(19) United States
(12) Patent Application Publication
(10) Pub. No.: US 2014/0353300 A1
(43) Pub. Date: Dec. 4, 2014

(54) AUTOMATED LOCAL THERMAL MANAGEMENT SYSTEM

(71) Applicants: John A. Swiatek, Shelby Township, MI (US); Michael J. Bush, Gowen, MI (US); Tommy Fristedt, Highland, MI (US); William Burgett, Lake Orion, MI (US); John Mach, Troy, MI (US); Edward Burley, Troy, MI (US)

(72) Inventors: John A. Swiatek, Shelby Township, MI (US); Michael J. Bush, Gowen, MI (US); Tommy Fristedt, Highland, MI (US); William Burgett, Lake Orion, MI (US); John Mach, Troy, MI (US); Edward Burley, Troy, MI (US)

(21) Appl. No.: 14/295,171

(22) Filed: Jun. 3, 2014

Related U.S. Application Data
(60) Provisional application No. 61/830,416, filed on Jun. 3, 2013.

(51) Int. Cl. H05B 1/02

(52) U.S. Cl. CPC H05B 1/0272
USPC 219/211

(57) ABSTRACT

The automated local thermal management system (20) includes a plurality of heated clothing articles (22). A first control device (36) with a first microcontroller (52) having a first memory includes a plurality of output drivers (28) each electrically connected to a vehicle power source and to the heated clothing articles (22) for providing an output current to the heated clothing articles (22). The first control device (36) further includes a Bluetooth transceiver (54) to adjust settings and to monitor operation and a first RF transceiver (64). A second control device (74) with a second microcontroller (94) having a second memory includes a pair of buttons (96) and an accelerometer (112) and a thermistor (106) and a second RF transceiver (108) for wireless communication with said first RF transceiver (64). The second memory contains software instructions for monitoring and processing readings from the buttons (96) and the accelerometer (112) and the thermistor (106) for varying the output current in response to changes in readings from the buttons (96) and thermistor (106) and accelerometer (112).

### CROSS REFERENCE TO RELATED APPLICATION

This application claims the benefit of provisional application Ser. No. 61/830,416 filed Jun. 3, 2013.

### BACKGROUND OF THE INVENTION

1. Field of the Invention

An automated local thermal management system useful for adjusting and controlling the temperature of clothing.

2. Description of the Prior Art

Heated clothing has been used for many years to provide warmth to motorcycle riders and other outdoor enthusiasts. These systems are comprised of a garment that contains heating elements, a power source and a control mechanism to turn on/off the heaters. People engaged in other outdoor activities such as hunters, snowmobile riders, high-low drivers, construction workers, and golf enthusiasts can also benefit from these heated clothing systems. Simple on/off switches were originally used to control the heating elements. Rheostats started to replace switches as they provided a variable amount of heat, not simply on/off. Over time, digital controls that use pulse width modulation replaced rheostats as the preferred method of variable control.

A thermal management system is disclosed in U.S. Pat. No. 8,084,722 by Haas et al. that includes at least one heated clothing article including a plurality of wiring connectors for electrical connection. A first control device includes a processor. The first control device includes at least one output driver producing an output current and electrically connected to the processor and to a power source and to the heated clothing article for providing the output current to the heated clothing articles through the wiring connectors. However, there remains a need for a thermal management system that further reduces the required interaction between the user and the automated local thermal management system to achieve a requested warmth. Completely eliminating the need to manually control is desirable since the vehicle operator is faced with changes in ambient temperature along with wind chill due to vehicle speed while being challenged with the demands of operating the vehicle or other demands to his or her attention.

### SUMMARY OF THE INVENTION

The invention provides for such an automated local thermal management system including at least one user input and a velocity input and at least one temperature input each in communication with the processor. The processor contains software instructions for monitoring and processing readings from the user input and the velocity input and the temperature input for varying the output current of the output driver in response to changes in the user input and the temperature input and the velocity input readings by the processor.

### Advantages of the Invention

The subject invention provides an automated local thermal management system that automatically compensates for changes in ambient temperature and wind chill due to vehicle speed using a simplified control that provides for a much higher level of comfort, convenience and safety. Instead of having to adjust various knobs or controls for each heated clothing article separately, the user only needs to adjust temperature through a single automated local thermal management system. This provides the user with the luxury of not being required to interact with the automated local thermal management system as often as required in systems with separate controls or those that do not compensate for changes in ambient temperature and air velocity speed. These subject invention can also be used indoors to conserve energy by improving comfort in a wider than normal range of indoor temperatures.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of the preferred embodiment of the subject invention;

FIG. 2 is a perspective view of the first control device of the preferred embodiment of the subject invention;

FIG. 3 is a perspective view of the first control device of the preferred embodiment of the subject invention illustrating the first printed circuit board;

FIG. 4 is a perspective view of the second control device of the preferred embodiment of the subject invention;

FIG. 5 is a perspective view of the second control device of the preferred embodiment of the subject invention illustrating the second printed circuit board;

FIG. 6 is a perspective view of the second control device of the preferred embodiment of the subject invention illustrating the second printed circuit board;

FIG. 7 is a block diagram of the first control device;

FIG. 8 is a block diagram of the second control device;

FIG. 9 is a block diagram of the CAN dongle;

FIG. 10 is an enlarged view of the heated clothing articles of the preferred embodiment of the subject invention;

FIG. 11 is an enlarged view of the heated clothing articles of the preferred embodiment of the subject invention;

FIG. 12 is a perspective view of personal electronic equipment displaying the software application of the subject invention;

FIG. 13 is a perspective view of personal electronic equipment displaying the software application of the subject invention;

FIG. 14 is a perspective view of personal electronic equipment displaying the software application of the subject invention;

FIG. 15 is a perspective view of personal electronic equipment displaying the software application of the subject invention;

FIG. 16 is a perspective view of personal electronic equipment displaying the software application of the subject invention;

FIG. 17 is a perspective view of personal electronic equipment displaying the software application of the subject invention;

FIG. 18 is a perspective view of personal electronic equipment displaying the software application of the subject invention;

FIG. 19 is an enlarged view of a comparison between the pattern of carbon filaments of the subject invention and a prior art pattern of carbon filaments; and

FIG. 20 is an enlarged view of the heated clothing articles of the preferred embodiment showing the pattern.

### DETAILED DESCRIPTION OF THE ENABLING EMBODIMENTS

Referring to the Figures, wherein like numerals indicate corresponding parts throughout the several views, a heated clothing wireless temperature control apparatus constructed in accordance with the subject invention is shown in the Figures.

Thermodynamics is the science of how thermal energy (heat) moves, transforms, and affects all matter. The first law of thermodynamics is a scientific law that states when mechanical work is transformed into heat, or when heat is transformed into work, the amount of work and heat are always equivalent. Energy cannot be created or destroyed, only altered. The second law of thermodynamics states when a temperature difference exists between two objects, thermal energy transfers from the warmer areas (higher energy) to the cooler areas (lower energy) until thermal equilibrium is reached. A transfer of heat results in either electron transfer or increased atomic or molecular vibration.

Energy, in a process called heat transfer or heat flow, is constantly flowing into and out of all objects, including living objects. Heat flow moves energy from a higher temperature to a lower temperature. The bigger the difference in temperature between two objects, the faster heat flows between them. When temperatures are the same there is no change in energy due to heat flow.

It is important to know how much supplemental heat is needed to theoretically keep a human body warm under specific conditions (e.g. typical motorcycle riding). Heat has the units of energy, which is a quantity. Heat flow has the units of power, which is the rate that energy is being transferred. In the real world you can't stop the heat flow. Energy is flowing into and out of your body, and everything else, all the time.

Since one of the goals in designing heated clothing is to delay or eliminate the onset of hypothermia, it is necessary to also have a reasonable understanding of hypothermia. Hypothermia is a medical emergency that occurs when your body loses heat faster than it can produce heat, causing a dangerously low body temperature. Normal body temperature is around 98.6 F (37 C). Hypothermia occurs as the body temperature passes below 95 F (35 C). Hypothermia is most often caused by exposure to cold weather or immersion in a cold body of water. Primary treatments for hypothermia are methods to warm the body back to a normal temperature.

To significantly prolong or completely eliminate the onset of hypothermia compared to the human body alone, a reasonable target would be the efficient conversion of 50 watts of electrical energy into heat in a human body using well placed, well designed heating elements. Since hypothermia is defined as a drop of 3.6° F., external heat flow can be used to delay or eliminate hypothermia.

Carbon nanotechnologies can have an inroad for heating elements. In Japan, Kuraray Living has developed a full-face heating fabric using CNTEC, a carbon nanotube coated electro conductive fiber. This fiber was co-developed with Hokkaido University and others. This product uses conventional technology for the polyester fibers and carbon nanotubes, a cutting-edge material, as a coating for the fibers. The nanotubes are applied using conventional dye-printing technology, with a carbon nanotube network forming on the surface of every filament in the multi-filament structure. The resulting fabric is thin, lightweight, flexible and soft, and has a high level of washing durability. To maximize the efficiency of the heating element, and reduce the “heat signature” in military applications, it is desirable to incorporate a thermal mirror.

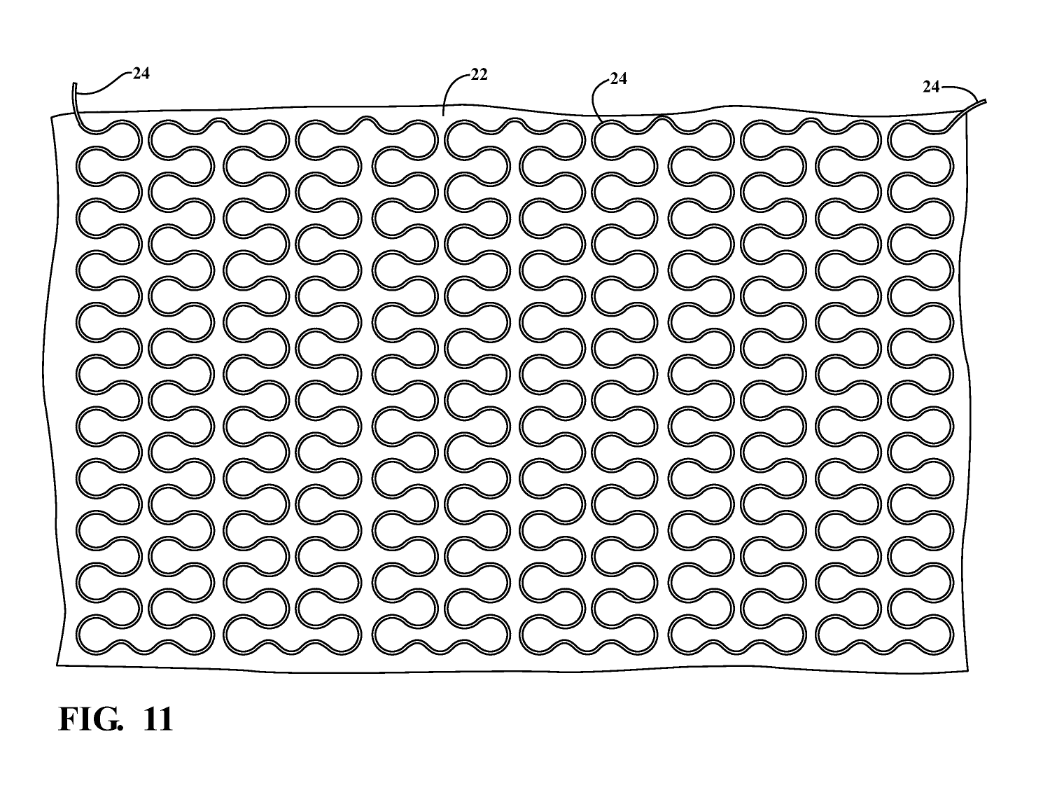

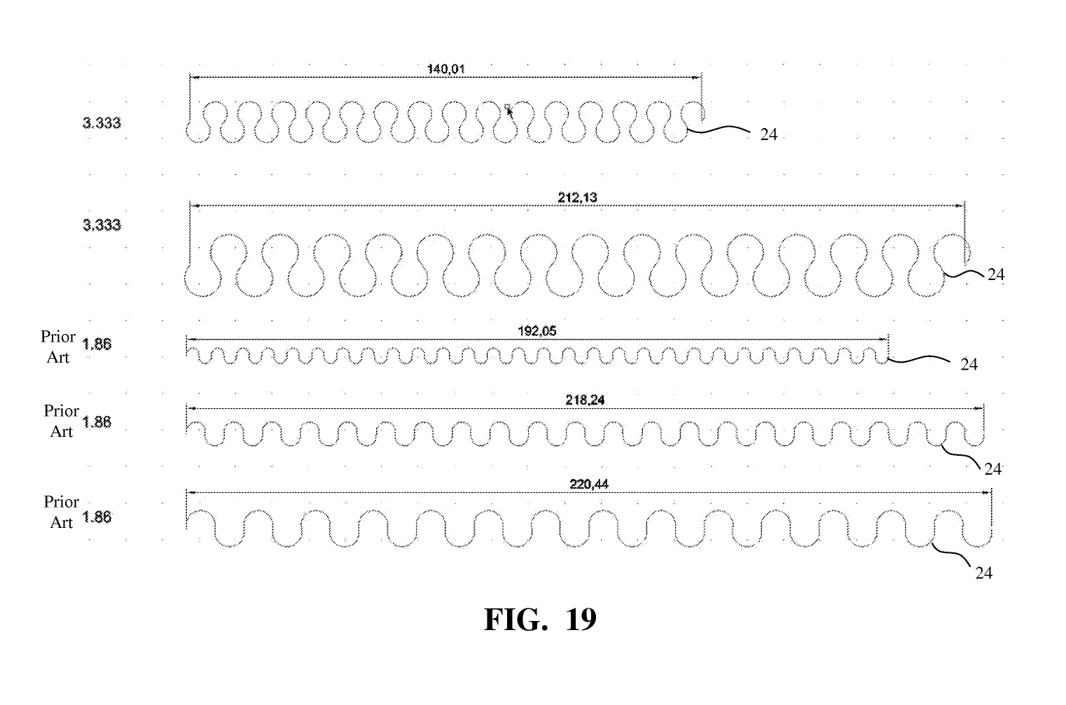

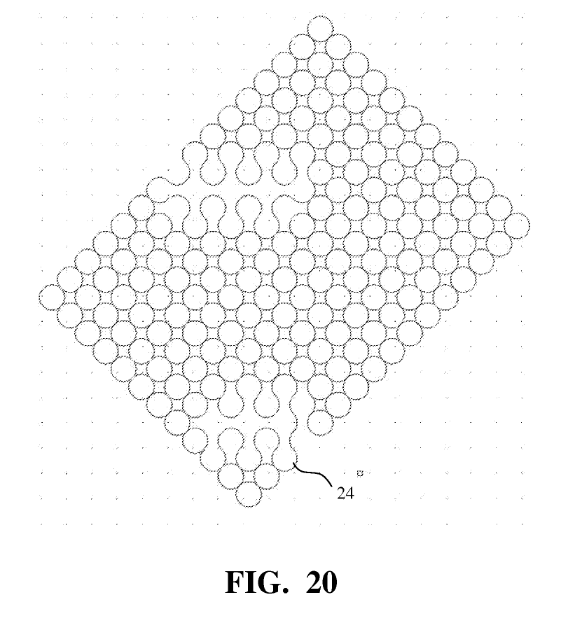

The automated local thermal management system 20, generally shown, includes a plurality of heated clothing articles 22, generally indicated, each including a plurality of carbon filaments 24. While the heated clothing articles 22 in the preferred embodiment include heated jackets, gloves, pant liners, chaps, and socks, it should be appreciated that the automated local thermal management system 20 could be used to control various other items such as, but not limited to heated seats, heated mirrors or any other heated items that may come in contact by a user of the automated local thermal management system 20. Although carbon filaments 24 are utilized in the preferred embodiment, it should be appreciated that any conductive material that can be used as a heating generating medium such as metal, metal alloy, conductive polymer, carbon nanotubes or other alternative heating elements may be used instead. Open circuits or breaks in the carbon filaments 24 or in other alternative heat generating medium can cause undesirable “hot spots” due to remaining unbroken filaments conducting additional current due to the loss of the ability of the broken filament to carry its share of the current. Therefore, each carbon filament 24, carbon nanotube, or other heat generating filament may additionally be individually coated with an electrically insulating material in order to create a separate electrical conductor within the filament bundle for each individually insulated part and therefore provide safer failure modes, avoiding hot areas during wire breaks. The carbon filaments 24 are woven into the heated clothing articles 22 in a specific pattern based on a continuous curve (FIGS. 10 and 11) in order to minimize mechanical stress on the wire that could generate breaks or damage to the metallic or carbon filaments 24 as the heated clothing articles 22 are stretched, folded, or moved in different directions. The pattern is a result of using a continuous array of circles (FIG. 20), possibly of different diameters, to get the resulting pattern. More specifically, this pattern is based on a continuous curve in such a way that there is no straight lines in the pattern and that for an ideal pattern, the relation of the heat generating filament length to the length of the pattern is 3.333 (FIG. 19). In production, this relation may be varied slightly and could also be adjusted for various reasons including, but not limited to designing to a certain target resistance. The useful span of this relation is generally between approximately 3.0 and 3.6. The pattern may be based on different sized circular shapes. This specific pattern provides flexibility and stretchability in all directions and protects the carbon filaments 24 from pull forces. The continuous curve of the carbon filaments 24 enable a wrinkling of the surface of the heated clothing article 22 which tends to give a twisting movement to the carbon filament 24 rather than a sharp bending and thus enable a longer mechanical flex life. Additionally, the specific pattern enables a mechanically softer “feel” to the heated clothing articles 22 as compared to other patterns using the same metal or carbon filaments 24. The metal or carbon filaments 24 may also be integrated into the heated clothing articles 22 in parallel following the same circular pattern (e.g. double or triple metal or carbon filament 24 configurations). The parallel carbon filaments 24 may be laid out in such a way that they are covering a wider path than a single carbon filament 24 can do and therefore will spread the heat over the area better. Also it enables alternative points of connections as a single circular path can carry current in both directions (i.e. one direction per each wire in the dual bundle). Several carbon filaments 24 or other conductive filaments laid out beside each other enables using thinner metal or carbon filaments 24 or filament bundles that can make a heated area thinner and softer and more comfortable. Increased length of the metal or carbon filaments 24 within the heating area enables the usage of lower temperatures of metal or carbon filaments 24 (lower wattage per length of each individual metal or carbon filament 24) and is therefore safer and more thermally and mechanically comfortable.

Several data communication bus structures are used in today's vehicles to control a wide variety or electrical and electromechanical devices. Such bus structures include but are not limited to CAN bus (Controller Area Network) and LIN (Local Interconnect Network). LIN is often used as an in-vehicle communication and networking serial bus between intelligent sensors and actuators operating at 12 volts. Other auto body electronics include air conditioning systems, doors, seats, column, climate control, switch panel, intelligent wipers, and sunroof actuators. The LIN specification covers the transmission protocol and the transmission medium. Another common communications bus standard is CAN bus (or CANBUS). CAN provides a method for microcontrollers and devices to communicate with each other within a vehicle without a host computer. CAN bus is a message-based protocol, designed specifically for automotive applications but now also used in other areas such as aerospace, maritime, industrial automation and medical equipment. Many other common and proprietary bus systems would work with the microclimate control system. Other present or future data communication bus systems and methods may be used by the automated local thermal management system 20 to receive and transmit data.

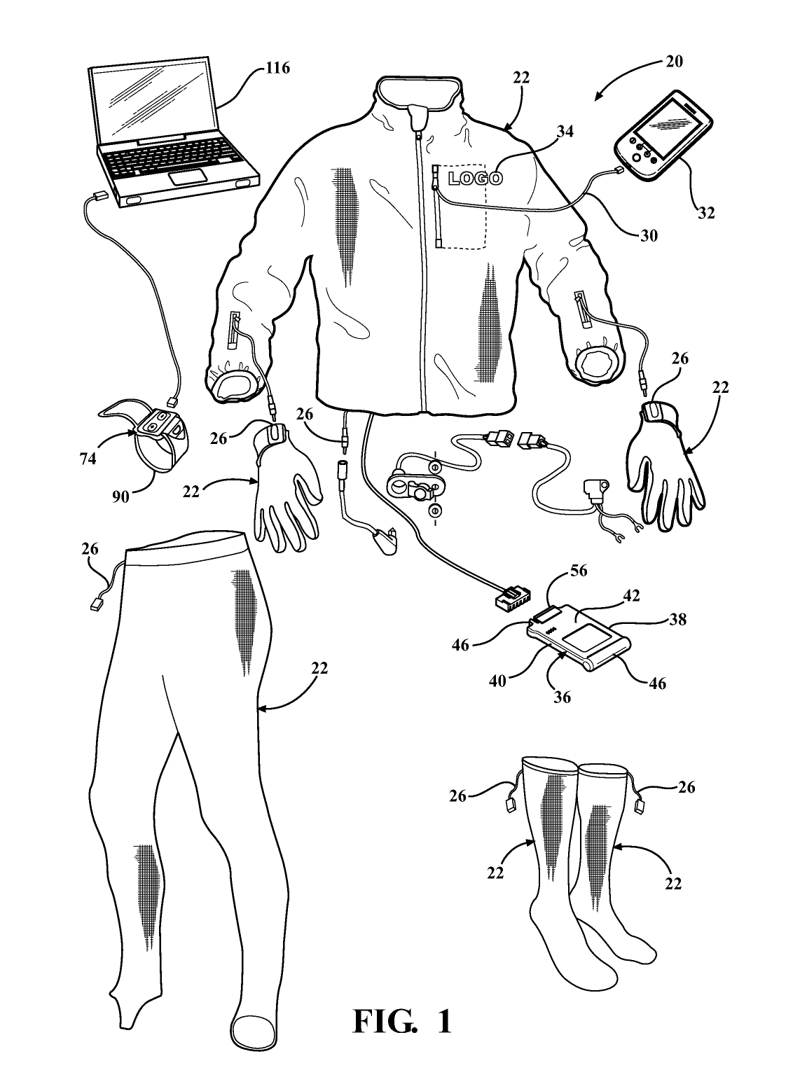

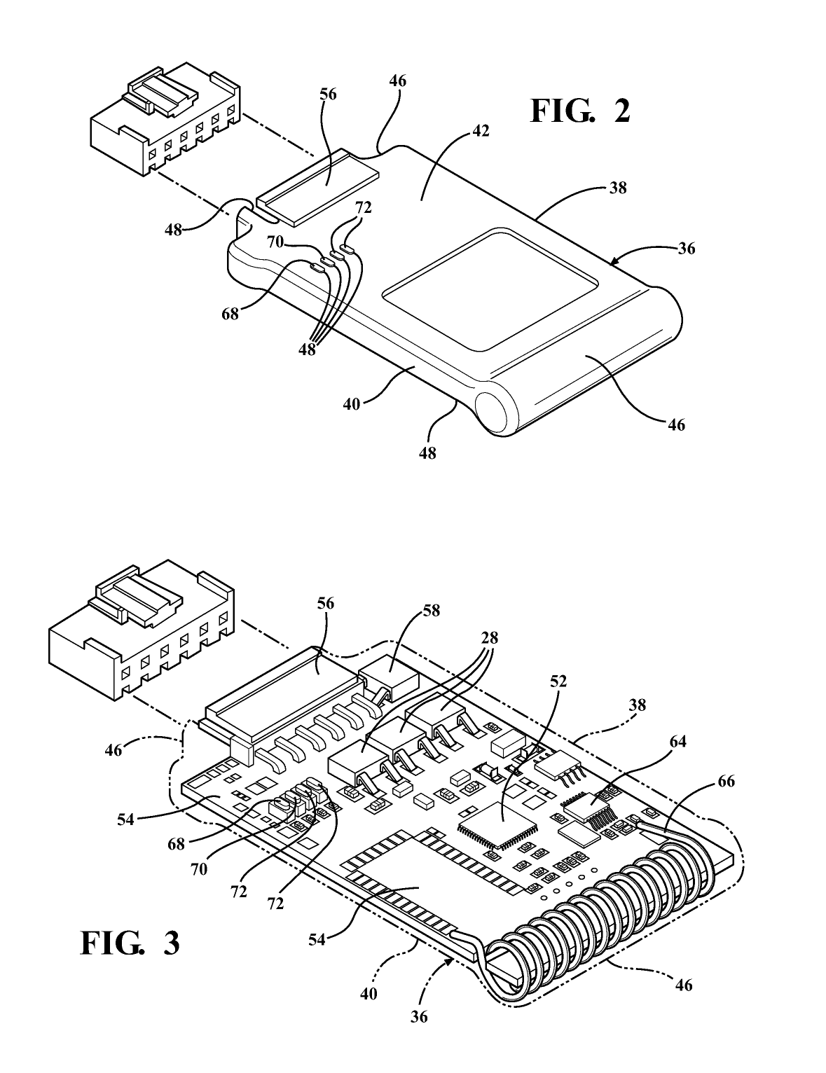

As best shown in FIG. 1, each heated clothing article 22 also includes a plurality of wiring connectors 26 for electrical connection. The wiring connectors 26 are configured to not allow the heated clothing article 22 to be used alone. Additionally, the wiring connector 26 can accommodate the use of temperature sensors in the heated clothing articles 22. More specifically, additional temperature sensors (e.g. resistance temperature detectors or RTDs) may be placed on the wiring crimp connecting the leads to the carbon filaments 24 and electrically connected to the automated local thermal management system 20 in order to provide temperature feedback and reduce the occurrence of “hot spots” at the junction of the leads and carbon filaments 24. In the event that the automated local thermal management system 20 detects an elevated temperature, it may limit the output current from the output drivers 28. Additionally, the sensor and crimp will be contained within an airtight insulated enclosure. Because of the low mass of certain types of heat generating filaments such as the carbon filament 24, the lead will act as a heat sink which will help limit the heating of the junction.

At least one of the heated clothing articles 22 includes an interface cable 30 for attachment to personal electronic equipment 32 (e.g. smart phone, music player, etc.) to enable charging of the personal electronic equipment 32 while the personal electronic equipment 32 is safely stored in a pocket. The interface cable 30 (e.g. a USB interface) could also enable the personal electronic equipment 32 to communicate to the heated clothing article 22 and automated local thermal management system 20 via the USB interface, for example. The heated clothing article 22 also includes a lighted logo 34. The lighted logo 34 includes a plurality of integrated lighting elements (e.g. LEDs) woven into the fabric of the heated clothing article 22.

This automated local thermal management system 20 can be used by motorcycle riders as well as people engaged in other outdoor activities such as hunters, snowmobile riders, high-low drivers, construction workers, and golf enthusiasts. However, the automated local thermal management system 20 is not limited to these uses. The automated local thermal management system 20 may also be used to create a microclimate or personal climate in other applications such as a wheel chair with heated components, heated articles used with a convertible vehicle, or building or other enclosure that is kept cooler to conserve energy.

A first control device 36, generally indicated, includes an enclosure having an upper portion 38 and a lower portion 40 and an anterior portion 42 and a posterior portion 44 and a pair of walls 46 defining an inside chamber and defining a plurality of openings 48 extending into the inside chamber. The first control device 36 may be placed within one of the heated clothing articles 22. A first printed circuit board 50 is disposed in the inside chamber of the enclosure. A first microcontroller 52 (FIGS. 3 and 7) having a first memory is attached to the first printed circuit board 50. A plurality of output drivers 28 (e.g. high-side P-channel drivers) are attached to the first printed circuit board 50 and are electrically connected to the first microcontroller 52 and to the heated clothing articles 22 for providing power to the heated clothing articles 22 through the wiring connectors 26. The output drivers 28 also detect an electrical connection to the heated clothing articles 22. In the preferred embodiment, a Bluetooth transceiver 54 (FIGS. 3 and 7) is attached to the first printed circuit board 50 and is electrically connected to the first microcontroller 52 for wireless communication with Bluetooth or equivalent enabled personal electronic equipment 32 to adjust settings and monitor operation of the automated local thermal management system 20. However, the Bluetooth enabled personal electronic equipment 32 could also provide other information to the automated local thermal management system 20 such as, but not limited to weather information that could be used to proactively adjust the temperature of the heated clothing articles 22 in preparation for a future change in weather conditions. Although the processor of the first control device 36 in the preferred embodiment is the first microcontroller 52 having the first memory, it should be appreciated that other embodiments of the present invention could utilize alternatives such as, but not limited to customized Application-Specific Integrated Circuits (ASIC), digital gate arrays, or analog circuits instead, making it less expensive to integrate the first control device 36 into the heated clothing article 22 itself.

A wiring socket 56 is attached to the first printed circuit board 50 and protrudes through one of the openings 48 disposed on the wall 46 of the enclosure. The pin out of the wiring socket 56 of the first control device 36 of preferred embodiment is as follows: Pins 1 and 2—power source, Pin 3—PWM Out1, Pin 4—PWM Out2, Pin 5—ID (Open=Jacket, GND=Pants), Pin 6—power source ground. The wiring socket 56 is electrically connected to the output drivers 28, the wiring connectors 26 of the heated clothing articles 22, and to the positive and negative terminal of a vehicle power source. The automated local thermal management system 20 of the preferred embodiment is powered from the vehicle, a portable/rechargeable battery pack, or a combination of vehicle power and battery pack via the wiring connector 26. However, it should be appreciated that power may alternatively be provided inductively. This inductive power could be provided through coils built into the vehicle and corresponding with coils integrated into the heated clothing articles 22, or could even be integrated into walls 46, floor, or ceiling of a building in which the automated local thermal management system 20 is being used. Because the first control device 36 is capable of detecting the type of power source, it can select a different running profile for each type of power source being used. For example, in the event that the first control device 36 and heated clothing articles 22 are using power from a battery pack, the first control device 36 will decrease the amount of power going to the heated clothing articles 22 in order to extend the life of the battery pack. The transition from wired or inductive power to operating exclusively with the battery pack is achieved seamlessly, the automated local thermal management system 20 automatically adjusts output current of the output drivers 28 depending on the power source available. However, the proposed control method does not allow the operator to plug the heated clothing into a power source without using a first control device 36.

In the preferred embodiment, the first control device 36 is connected to the heated clothing article 22 and is powered via internal wiring from either the vehicle or the battery pack. A battery charging circuit can be added to the first control device 36 to make a hybrid power source system. In this embodiment the heated clothing articles 22 are powered from a vehicle or a battery source. The vehicle power can be routed by the first control device 36 to both power the heated clothing articles 22 and recharge the battery pack simultaneously. Power is automatically prioritized based on if the first control device 36 detects it has battery power or vehicle power available. A reverse battery protection circuit 58 is attached to the first printed circuit board 50 and is electrically connected to the wiring socket 56 for protecting the first control device 36 from reversal of the positive terminal and negative terminal of the vehicle power source by disabling operation of the first control device 36. A voltage regulator 60 is attached to the first printed circuit board 50 and is electrically connected to the vehicle power source for regulating voltage supplied to the first control device 36. A voltage monitor 62 is attached to the first printed circuit board 50 and is electrically connected to the first microcontroller 52 and to the wiring socket 56 for monitoring the voltage of the vehicle power source. A first RF transceiver 64 (e.g. 433 Mhz) is attached to the first printed circuit board 50 and is electrically connected to the first microcontroller 52 for wireless communication. A first antenna 66 is attached to the first printed circuit board 50 and is electrically connected to the first RF transceiver 64 for transmitting a first radio frequency signal from the first RF transceiver 64 and for receiving radio frequency signals.

At least one status indicating device such as a Light Emitting Diode (LED) is attached to the first printed circuit board 50 and protrudes through one of the openings 48 disposed on the anterior portion 42 of the enclosure. In the preferred embodiment, one of these status indicating devices is a status LED 68. The status LED 68 is electrically connected to the first microcontroller 52 for visual feedback to a user of the status (e.g. power on/off) of the first control device 36. At least one reverse polarity LED 70 is attached to the first printed circuit board 50 and protrudes through one of the openings 48 disposed on the anterior portion 42 of the enclosure for providing visual status feedback to the user in response to the user reversing the attachment of the positive terminal and the negative terminal of the vehicle power source to the wiring socket 56. A plurality of heater output LEDs 72 are attached to the first printed circuit board 50 and each protrudes through one of the apertures disposed of the anterior portion 42 of the enclosure. Each of the heater output LEDs 72 are electrically connected to the first microcontroller 52 for visual feedback to the user of the output of the output drivers 28. Although the status indicating devices are all LEDs in the preferred embodiment, other devices such as, but not limited to light bulbs may be used instead.

The first memory of the first microcontroller 52 contains computer instructions for processing information received by the first RF transceiver 64 and by the Bluetooth transceiver 54 to control the status LED 68 and the heater output LEDs 72 and to generate a pulse width modulated (PWM) output to command the output drivers 28 in order to alter the temperature of the heated clothing articles 22. A plurality of zones are defined by the first memory of the first microcontroller 52 and each contains at least one of the heated clothing articles 22 (e.g. torso, hands, legs, and feet) for temperature adjustment of the heated clothing articles 22 by the first microcontroller 52. At least one output driver 28 is needed for each zone. More than one first control device 36 can be used. This could allow the integration of one first control device 36 into a jacket that can control the torso and hands and an additional first control device 36 in the pants to control the legs and feet. In the case of overalls, one first control device 36 could control all zones.

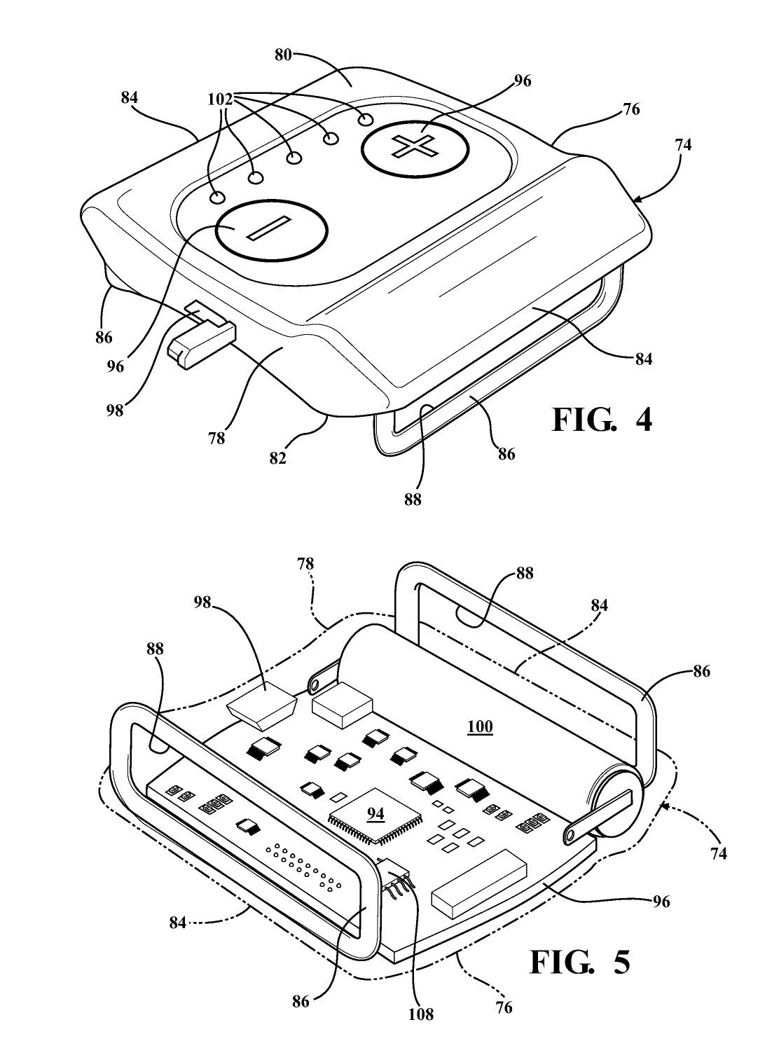

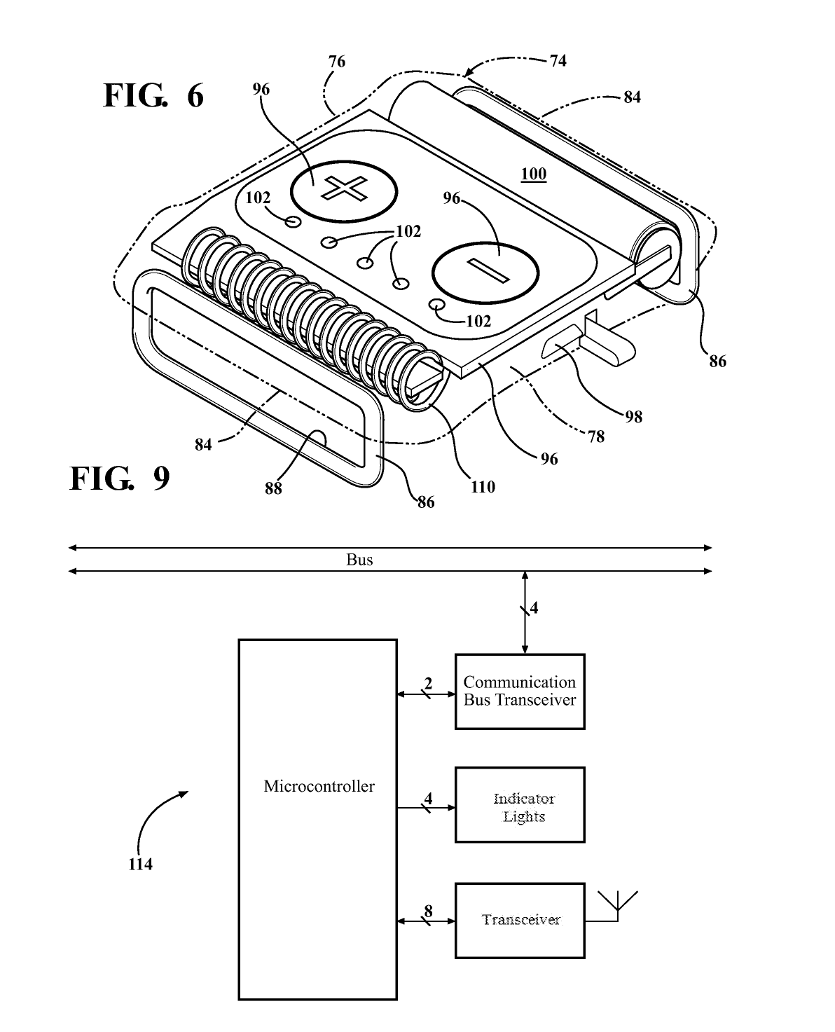

A second control device 74, generally indicated, includes a housing having a top 76 and a bottom 78 and a front 80 and a back 82 and a pair of sides 84 which define an interior cavity and a plurality of apertures extending into the interior cavity. The housing is designed to be exposed to atmospheric elements and the preferred embodiment conforms to Ingress Protection (IP67). The housing includes a pair of protrusions 86 each disposed adjacent to one of the sides 84 and extending outwardly from the back 82 of the housing (FIGS. 4,5, and 6). The protrusions 86 each define a longitudinal slot 88 extending from the top 76 of the housing to the bottom 78 of the housing. A flexible strap 90 (FIG. 1) having a plurality of hook and loop patches extends through the longitudinal slots 88 between the protrusions 86 for securing the housing to a wrist of the user, or alternatively to a vehicle brake reservoir or a handlebar of a vehicle.

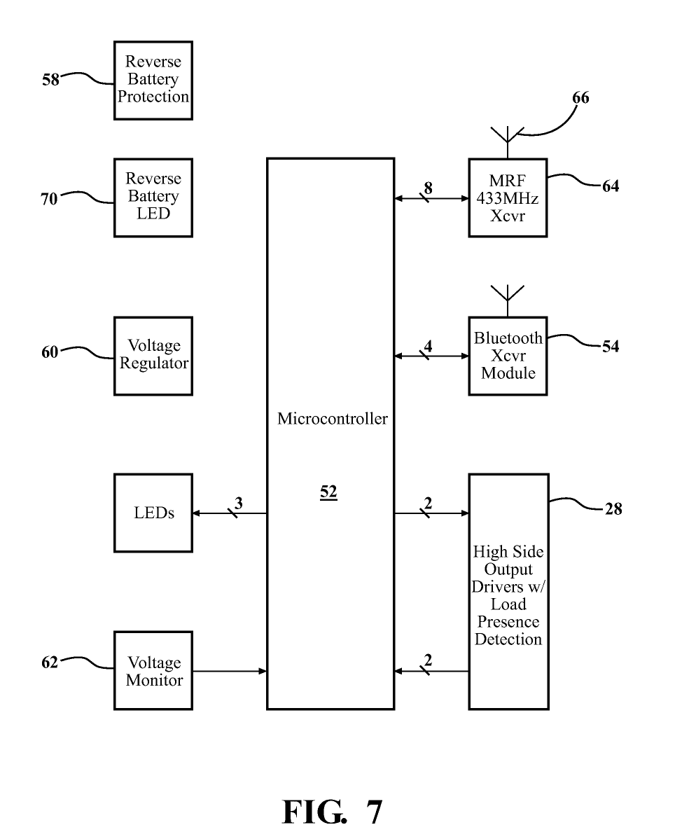

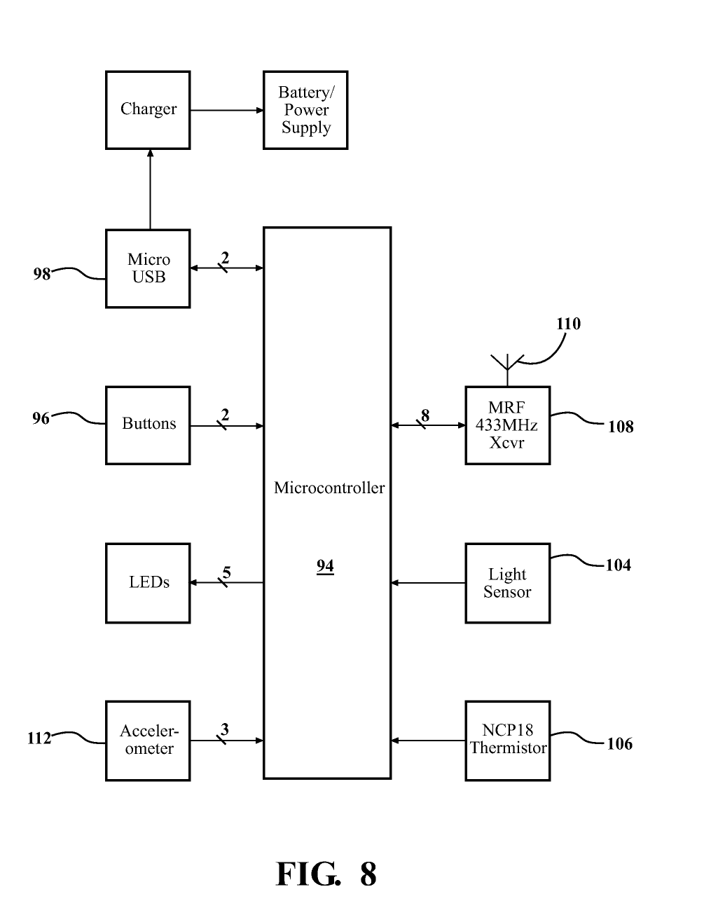

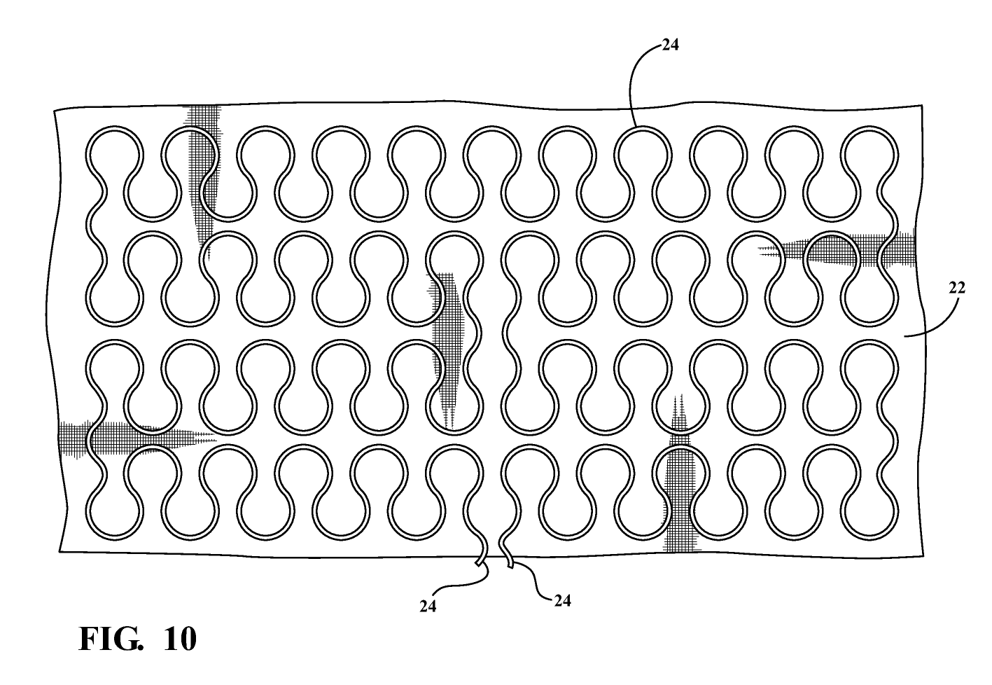

A second printed circuit board 92 is disposed in the interior portion of the housing. A second microcontroller 94 (FIGS. 5 and 8) having a second memory is attached to the second printed circuit board 92. Although the processor of the second control device 74 in the preferred embodiment is the second microcontroller 94 having the second memory, it should be appreciated that other embodiments of the present invention could utilize alternatives such as, but not limited to customized Application-Specific Integrated Circuits (ASIC), digital gate arrays, or analog circuits instead. The second control device 74 includes a user input. In the preferred embodiment, the user input is a plurality of buttons 96 that are attached to the second printed circuit board 92 and each protrudes through one of the apertures disposed on the front 80 of the housing and is electrically connected to the second microcontroller 94 for the user to signal temperature changes in response to the buttons 96 being depressed. It should be appreciated that in embodiments where the use of the second control device 74 is not desirable, a smartphone can command the first control device 36.

directly. The buttons 96 are used to control power on/off, temperature in all of the zones (e.g. torso, hands, legs, and feet), and zone balance and pairing. A micro USB port 98 is attached to the second printed circuit board 92 and extends through one of the apertures disposed on the bottom 78 of the housing. The micro USB port 98 is electrically connected to the second microcontroller 94 for connection to a computer to reprogram, to configure settings, and for connection to an external power supply. A rechargeable mobile battery 100 is disposed in the interior portion of the housing and is electrically connected to the micro USB port 98 and to the second microcontroller 94 for providing electrical power to the second control device 74. The mobile battery 100 is recharged by the external power supply through the micro USB port 98.

A plurality of comfort setting LEDs 102 are attached to the second printed circuit board 92 and each protrudes through one of the apertures disposed on the top 76 of the housing. The comfort setting LEDs 102 are electrically connected to the second microcontroller 94 for visual feedback to the user in response to the user depressing the buttons 96 (i.e. the appropriate comfort setting LED 102 will light depending on the level setting of by the user). The five settings displayed by the LED's represent five “expectations of the operator” or “comfort settings” and are controlled by pressing the button 96. Each button 96 press can be programmed to actuate full step or parts of a step (½/, ¼, etc.). To indicate that the rechargeable mobile battery 100 state of charge is low, the comfort setting LED 102 in use at the time will blink to provide visual feedback to the user. Similarly, the lighting of the comfort setting LED 102 in use at the time provides visual status feedback to the user of activation of the second control device 74.

A light sensor 104 is attached to the second printed circuit board 92 and is aligned with one of the apertures disposed on the top 76 of the housing. It is electrically connected to the second microcontroller 94 for detecting ambient light and signaling the second microcontroller 94 to adjust the brightness of the comfort setting LEDs 102 (e.g. dimming during night use). A temperature input is also attached to the second printed circuit board 92 and electrically connected to the second microcontroller 94 for generating an electrical output proportional to an ambient temperature. In the preferred embodiment, this temperature input is a thermistor 106, however it should be appreciated that other alternative temperature inputs could be used. A second RF transceiver 108 is attached to the second printed circuit board 92 and is electrically connected to the second microcontroller 94 for wireless communication with the first control device 36. A second antenna 110 is attached to the second printed circuit board 92 and is electrically connected to the second RF transceiver 108 for transmitting a second radio frequency signal from the second RF transceiver 108 and for receiving the first radio frequency signal from the first antenna 66. By using a wireless control system the operator can place the control system in line-of-sight (e.g. second control device 74 on wrist of the operator or user), again reducing the time the vehicle operator spends making comfort adjustments. The wireless control also allows for the heated clothing article 22 to be worn outside of a second layer that can be used to protect or create the microclimate. This allows the operator to effectively add and subtract clothing layers with the push of a button. A velocity input is attached to the second printed circuit board 92 and is electrically connected to the second microcontroller 94 for transmitting a signal indicating a velocity of the housing to the second microcontroller 94. In the preferred embodiment, the velocity input takes the form of an accelerometer 112. Alternatively, a GPS receiver or microphone detecting environmental noise (e.g. wind noise) or any other means of sensing motion could be used instead of or in addition to the accelerometer 112 to determine velocity. This velocity sensing could also take the form of a CAN dongle 114 that may be attached to a diagnostic port of the vehicle and in communication with the vehicle to receive information such as vehicle speed directly from the vehicle to be used in adjusting the temperature of the clothing. Many users of smartphones enable velocity sensing, so this could also be provided by communications with the smartphone. This velocity sensing could also take the form of obtaining data from the vehicle's communications bus. One embodiment uses a CAN dongle 114 that may be attached to a diagnostic port of the vehicle and in communication with the vehicle to receive information such as vehicle speed directly from the vehicle to be used in adjusting the temperature of the clothing. The CAN dongle 114 can read CAN messages such as, but not limited to vehicle speed and send real time data, either by wire or wirelessly to the second control device 74. Other data can be provided includes user control and settings for the microclimate control system. In these instances vehicle operators can repurpose or multi-purpose the existing vehicle controls or develop dedicated controls to communicate messages to the automated local thermal management system 20 through the vehicle bus system. The CAN dongle 114 will also act as a pass through so that other CAN systems may be attached. Using the existing vehicle communications bus or providing a dedicated bus to communicate with the local thermal management system 20 components such as heated clothing articles 22, seats and backrests is desirable to ensure the highest levels of automation for user comfort, convenience and safety. A slower more cost effective bus structure such as LIN bus may also be used. Similarly, if a smartphone, tablet or Bluetooth enabled personal electronic equipment 32 is in communication with the first control device 36 through the Bluetooth transceiver 54 or through a the interface cable 30, velocity sensing could be done by utilizing the GPS receiver and/or accelerometers 112 built into many smartphones or tablets. In an embodiment in which the automated local thermal management system 20 is used in a building or other enclosure that is kept cooler to conserve energy, this communication with a smartphone or tablet could also provide the ability for the automated local thermal management system 20 to detect if the user has walked into or out of a building. This would allow the automated local thermal management system 20 to adjust the temperature of the heated clothing articles 22 accordingly.

The second memory of the second microcontroller 94 contains software instructions for monitoring the buttons 96, the accelerometer 112, the thermistor 106, and the light sensor 104 and processing and transmitting a PWM request to the first control device 36. Additionally, sensors may also be included for Rehman input (e.g. pulse rate, skin temperature, etc.) or in the heated clothing articles 22 to provide additional information to the first control device 36. The second control device 74 sends information back 82 to the first control device 36 so the communication is bi-directional. Two way communication is needed for a “sleep mode” function to save the run time of the mobile battery 100 of the second control device 74. The second memory is reprogrammable using a personal computer 116 connected to the micro USB port 98. Using the micro USB port 98 and a proprietary encryption algorithm, firmware updates can be provided by a dealer sales network and directly from a website using the micro USB port 98 to both the second control device 74 as well as the first control device 36 via the second control device 74 (or via the first control device 36 if connected through the Bluetooth transceiver 54 of the first control device 36). This will allow both the first control device 36 and second control device 74 to be upgraded in the field.

The second memory also includes a Pulse Width Modulation (PWM) algorithm and a plurality of PWM lookup tables for processing adjustments to the output current of the output drivers 28 of the first control device 36 and the PWM request is communicated to said first control device 36 by the second RF transceiver 108. PWM algorithm computation is minimized with the use of lookup tables. The PWM algorithm of the second memory controls the output temperature of the heated clothing articles 22. The lookup tables are generated in advance on a personal computer 116, much like an ignition or injection table for an Engine Control Unit (ECU). The final settings for the pulse width modulation are derived from an algorithm that compensates for a variety of inputs in the preferred embodiment such as ambient temperature from the temperature input, vehicle speed from the velocity input, vehicle voltage level from the voltage monitor 62, buttons 96 of the second control device 74, and zone controls 118 to determine the output current of the output drivers 28 of the first control device 36. The final PWM output is also affected by the input voltage detected by the voltage monitor 62 and is reduced if there is an over-voltage condition detected. The PWM algorithm operates in at least three heating modes including but not limited to: burst mode which provides an initial heat sensation to the user, re-comfort mode which adjust the amount of heat or cooling when the user is too cold or too hot, and maintenance mode which meets the users current level of comfort. The PWM algorithm may also utilize other inputs, including but not limited to Rehman inputs (i.e. human body sensing such as skin temperature and pulse rate), and temperature of the carbon filaments 24. The PWM algorithm may optionally adjust the final settings for the pulse width modulation based on the power source type (rechargeable battery pack or vehicle power). Different zone profiles are used if the heated clothing article 22 is powered from a battery pack than the profiles that are used if it is plugged into the vehicle. In this manner battery power can be conserved and optimize the temperature of the hands or feet if the operator prefers. As the user continues to adjust heat settings, the second control device 74 will begin to learn their personal preferences and adapt to ensure that base settings will provide the maximum level of comfort. This includes but is not limited to adjust the PWM for time of day, personal heat preference, as well as before and after meals.

In the case where the outer layer of clothing is not the same as the heated clothing article 22, the first control device 36 and second control device 74 communicate wirelessly. An alternate approach is used for heated clothing articles 22 where the carbon filaments 24 and protective outer layer are incorporated into one garment. In this garment configuration a lower cost wired system can exist between the first control device 36 and the second control device 74. In the case of a wired system, power for the second control device 74 is received through wiring in the heated clothing articles 22 and communication between the first control device 36 and second control device 74 is achieved using a controller area network (CAN Bus) or other wired communications scheme. For example, the second control device 74 could be connected to a connector (e.g. USB) in the heated clothing article 22 (e.g. sleeve of a jacket) which then is connected to the first control device 36. Additionally, communication between the heated clothing articles 22 could be achieved using a CAN bus or other communications network.

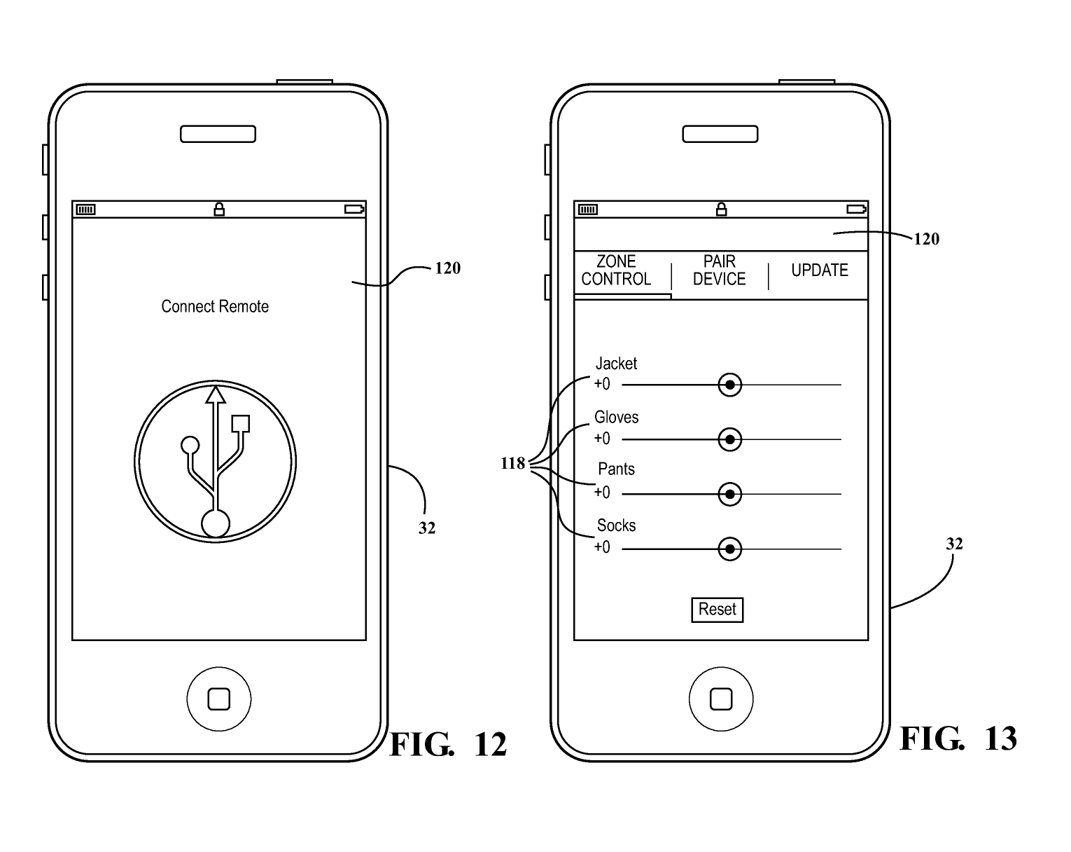

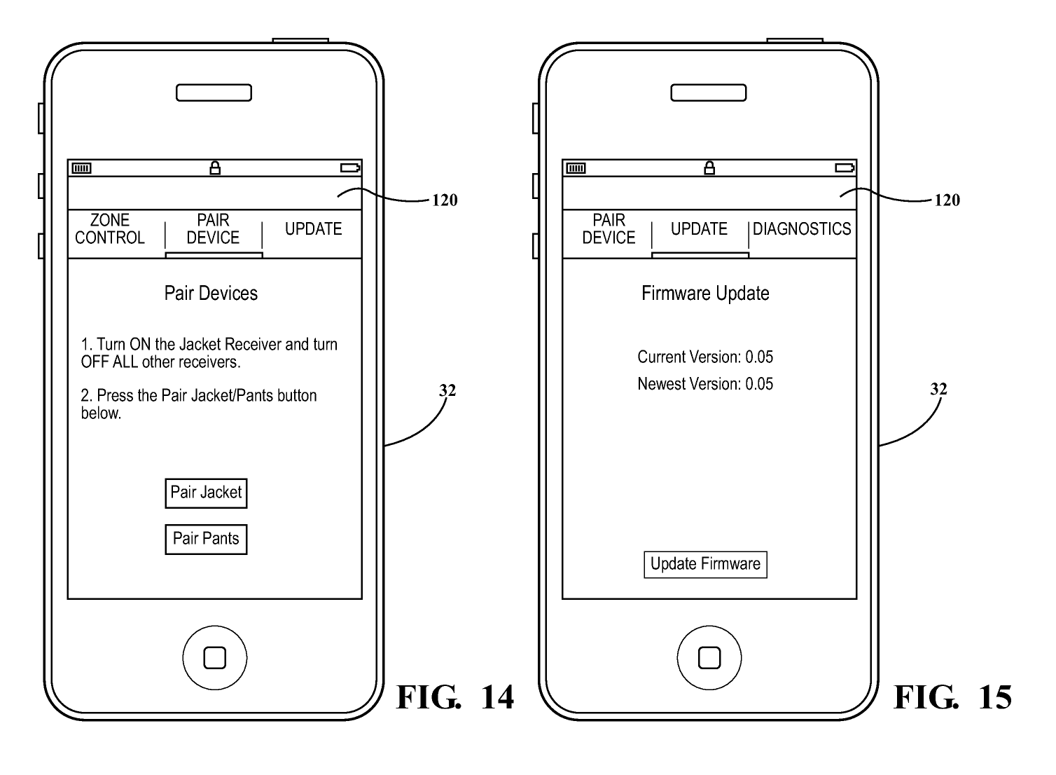

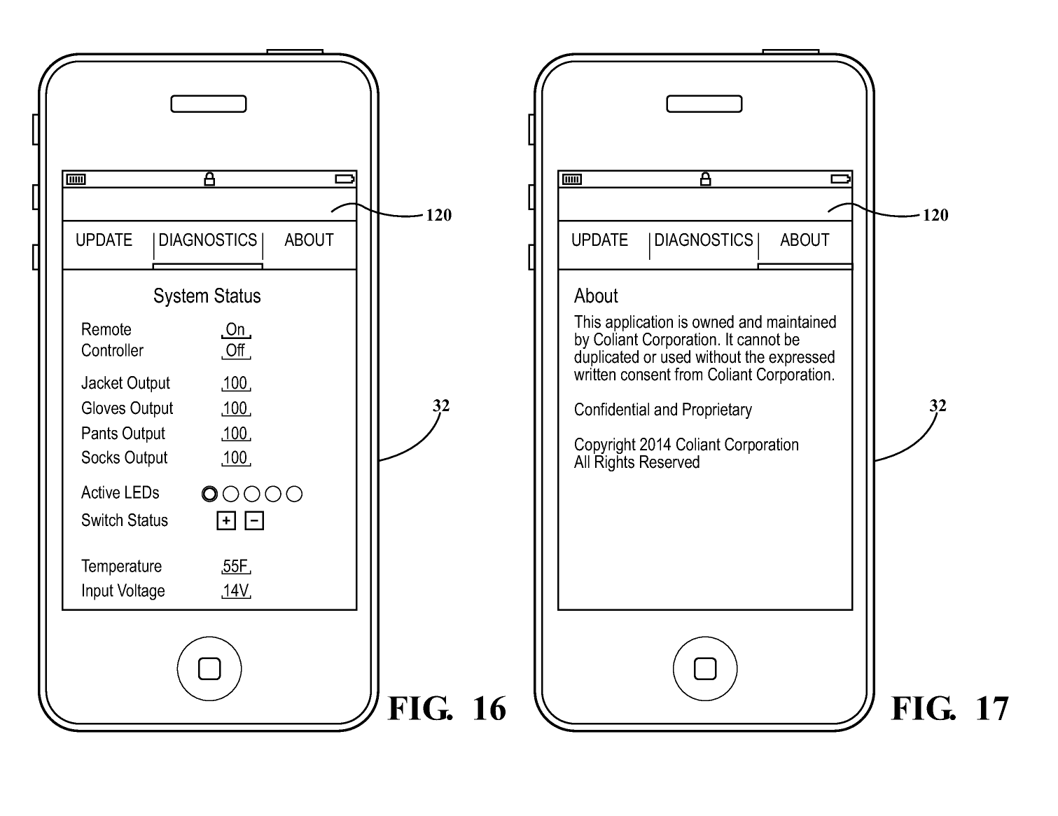

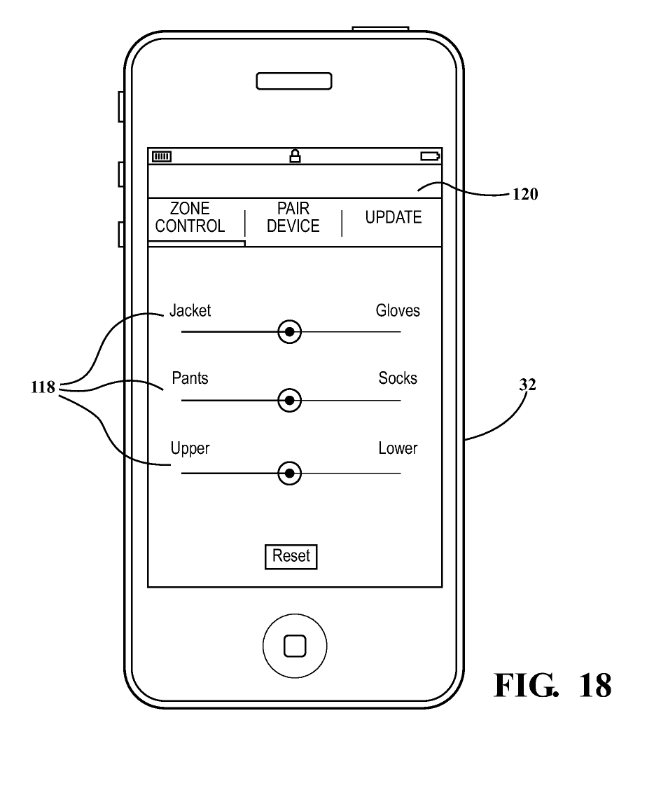

The first control device 36 and second control device 74 can be configured using either a personal computer 116 (FIG. 1) running custom software, or using a proprietary software application 120 running on a smartphone or tablet. The software application 120 aids in pairing the automated local thermal management system 20 to the smartphone or tablet, pairing heated clothing articles 22 to the automated local thermal management system 20 (FIG. 14), adjusting controls for the zones (FIGS. 13 and 18), updating firmware of the first control device 36 or second control device 74 (FIG. 15). The software application 120 may also connect to the second control device 74 through the micro USB port 98, in a “tethered” configuration (FIG. 12). The smartphone or tablet can also display the overall automated local thermal management system 20 status (FIG. 16). Items like ambient temperature from the second control device 74 are also displayed on the smartphone or tablet. Tuning is achieved in a similar fashion to that of a car radio's bass and treble bias with zone controls 118. A master volume on the radio controls the overall output while specific frequencies are enhanced or deemphasized by the bass and treble settings. Using the personal computer 116, smartphone, or tablet, the zones consisting of the torso, hands, legs and feet can be “offset” from a neutral setting to compensate for personal preference or better matching of the heating elements through the zone controls 118. The use of a simple master temperature on the second control device 74 combined with the ability to offset each zone with the zone controls 118 enables the user to control the heated clothing articles 22 in a simple, precise manner. Algorithm parameters can also be tuned via the smartphone or personal computer 116. Additionally, the software application 120 includes the ability to report errors and diagnostics of the automated local thermal management system 20 (FIG. 16), in order to enable remote diagnosis of issues to the manufacturer. User profile settings can be stored in the software application 120 to select a plurality of heated clothing article 22 configurations.

A plurality of inputs including vehicle speed, vehicle voltage, ambient temperature, weather, light sensing (sun load), heating element temperature, heating element junction temperature, human skin temperature, human pulse, zone settings, and comfort settings available to the automated local thermal management system 20 through the variety of sensors, wireless controls, analog to digital inputs, smartphones and bus systems. Automation is achieved using these inputs to define the PWM output algorithm. To achieve a high level of automation (minimal user interaction), the PWM algorithm is optimized for safety, comfort and convenience. Determining safe operation modes is the first priority of the PWM algorithm. For example, in the example embodiment described above, if the input supply voltage is too high for the specific heating elements used in the system, then the PWM output is either limited or turned off entirely. Similarly if the ambient temperature is too high for safe full power operation then the PWM is limited or turned off entirely. When the PWM is in an active output state the above embodiment then alters the PWM output based on the vehicle speed, zone bias settings, comfort settings and light sensing. Further refinement of the PWM output comes from learning the user preferences. For example in the above embodiment changes to the comfort settings are stored and analyzed to adjust the center point further reducing the need for future interaction with the automated local thermal management system 20. In this way the above embodiment demonstrates automation is based on function, design and learning from customer preferences.

Obviously, many modifications and variations of the present invention are possible in light of the above teachings and may be practiced otherwise than as specifically described while within the scope of the appended claims. The use of the word “said” in the apparatus claims refers to an antecedent that is a positive recitation meant to be included in the coverage of the claims whereas the word “the” precedes a word not meant to be included in the coverage of the claims. In addition, the reference numerals in the claims are merely for convenience and are not to be read in any way as limiting.

What is claimed is:

1. An automated local thermal management system (20) comprising;
at least one heated clothing article (22) including a plurality of wiring connectors (26) for electrical connection,
a first control device (36) including a processor,
said first control device (36) including at least one output driver (28) producing an output current and electrically connected to said processor and to a power source and to said heated clothing article (22) for providing said output current to said heated clothing articles (22) through said wiring connectors (26), and
said management system (20) including at least one user input and a velocity input and at least one temperature input each in communication with said processor for monitoring and processing readings from said user input and said velocity input and said temperature input for varying said output current of said output driver (28) in response to changes in said user input and said temperature input and said velocity input readings by said processor.

2. An automated local thermal management system (20) as set forth in claim 1 wherein said processor includes a first microcontroller (52) having a first memory defining a plurality of zones each containing at least one said heated clothing article (22) for temperature adjustment of said heated clothing article (22) by said first microcontroller (52).

3. An automated local thermal management system (20) as set forth in claim 1 further comprising a first RF transceiver (64) electrically connected to said first microcontroller (52) for wireless communication and a second control device (74) including a second microcontroller (94) having a second memory and a second RF transceiver (108) electrically connected to said second microcontroller (94) for wireless communication with said first RF transceiver (64),
said first memory of said first microcontroller (52) containing computer instructions for processing information received by said first RF transceiver (64) and generating a pulse width modulated command to said output drivers (28) to alter the temperature of said heated clothing article (22).

4. An automated local thermal management system (20) as set forth in claim 1 wherein said first control device (36) further comprising a Bluetooth transceiver (54) electrically connected to said first microcontroller (52) for wireless communication with Bluetooth enabled personal electronic equipment (32) to adjust settings and monitor operation of said first control device (36).

5. An automated local thermal management system (20) as set forth in claim 3 wherein said second memory also includes a Pulse Width Modulation (PWM) algorithm and a plurality of PWM lookup tables for processing adjustments to said output current of said output drivers (28) of said first control device (36) and communicating a PWM request to said first control device (36) by said second RF transceiver (108).

6. An automated local thermal management system (20) as set forth in claim 5 wherein said second control device (74) includes a housing defining an interior cavity and a plurality of apertures extending into said interior cavity and said user input includes a pair of buttons (96) protruding through one of said apertures of said housing and electrically connected to said second microcontroller (94) for signaling temperature changes in response to said buttons (96) being depressed and to control temperature in all of said zones.

7. An automated local thermal management system (20) as set forth in claim 6 further comprising a plurality of comfort setting LEDs (102) each protruding through one of said apertures of said housing and electrically connected to said second microcontroller (94) for visual feedback to a user in response to the user depressing said buttons (96) and for visual status feedback to the user of activation of said second control device (74).

8. An automated local thermal management system (20) as set forth in claim 7 wherein said second control device (74) further comprises a micro USB port (98) attached to said second microcontroller (94) and extending through one of said apertures disposed on said bottom (78) of said housing for connection to a personal computer (116) and to personal electronic equipment (32) to reprogram and to configure settings and for connection to an external power supply.

9. An automated local thermal management system (20) as set forth in claim 8 wherein said first control device (36) further comprises an enclosure defining an inside chamber and defining a plurality of openings (48) extending into said inside chamber and a plurality of heater output LEDs (72) each protruding through one of said apertures of said enclosure and electrically connected to said first microcontroller (52) for visual feedback to the user of the output current of said output drivers (28).

10. An automated local thermal management system (20) as set forth in claim 9 further comprising a wiring socket (56) protruding through one of said openings (48) of said enclosure and electrically connected to said output drivers (28) and to said wiring connectors (26) of said heated clothing articles (22) and to a positive and a negative terminal of the power source.

11. An automated local thermal management system (20) as set forth in claim 10 further comprising at least one reverse polarity LED (70) electrically connected to said first microcontroller (52) and protruding through one of said openings (48) of said enclosure for providing visual status feedback to the user in response to the user reversing the attachment of the positive terminal and the negative terminal of the power source to said wiring socket (56).

12. An automated local thermal management system (20) as set forth in claim 11 further comprising a reverse battery protection circuit (58) electrically connected to said wiring socket (56) for protecting said first control device (36) from reversal of the positive terminal and negative terminal of the vehicle power source by disabling operation of said first control device (36).

13. An automated local thermal management system (20) as set forth in claim 12 wherein said first memory of said first microcontroller (52) contains computer instructions for processing information received by said first RF transceiver (64) and by said Bluetooth transceiver (54) and controlling said reverse polarity LED (70) and said heater output LEDs (72).

14. An automated local thermal management system (20) as set forth in claim 1 wherein said heated clothing article (22) includes an interface cable (30) for attachment to personal electronic equipment (32) to enable charging of and communication with the personal electronic equipment (32).

15. An automated local thermal management system (20) as set forth in claim 6 wherein said housing of said second control device (74) including a pair of protrusions (86) extending outwardly from said housing and each defining a longitudinal slot (88) and said automated local thermal management system (20) further comprising a flexible strap (90) having a plurality of hook and loop patches and extending through said longitudinal slot (88) between said protrusions (86) for securing said housing to a wrist of the user and to a vehicle brake reservoir and to a handlebar of a vehicle.

16. An automated local thermal management system (20) as set forth in claim 7 further comprising a light sensor (104) electrically connected to said second microcontroller (94) and aligned with one of said apertures of said housing for detecting ambient light and signaling said second microcontroller (94) to adjust the brightness of said comfort setting LEDs (102).

17. An automated local thermal management system (20) as set forth in claim 16 wherein said second memory of said second microcontroller (94) contains software instructions for monitoring said buttons (96) and said velocity input and said temperature input and said light sensor (104) and processing and transmitting said PWM request to said first control device (36) and being reprogrammable by a personal computer (116) connected to said micro USB port (98) and being reprogrammable by personal electronic equipment (32) connected to said micro USB port (98).

18. An automated local thermal management system (20) as set forth in claim 1 wherein said temperature input is a thermistor (106).

19. An automated local thermal management system (20) as set forth in claim 1 wherein said velocity input is an accelerometer (112).

20. An automated local thermal management system (20) comprising;
a plurality of heated clothing articles (22) including a plurality of carbon filaments (24) and a plurality of wiring connectors (26) for electrical connection,
a first control device (36) including an enclosure having an upper portion (38) and a lower portion (40) and an anterior portion (42) and a posterior portion (44) and a pair of walls (46) defining an inside chamber and defining a plurality of openings (48) extending into said inside chamber,
a first printed circuit board (50) disposed in said inside chamber of said enclosure,
a first microcontroller (52) having a first memory attached to said first printed circuit board (50),
a plurality of output drivers (28) each having an output current and attached to said first printed circuit board (50) and electrically connected to said first microcontroller (52) and to said heated clothing articles (22) for providing said output current to said heated clothing articles (22) through said wiring connectors (26) and detecting an electrical connection to said heated clothing articles (22),
a first RF transceiver (64) attached to said first printed circuit board (50) and electrically connected to said first microcontroller (52) for wireless communication,
a first antenna (66) attached to said first printed circuit board (50) and electrically connected to said first RF transceiver (64) for transmitting a first radio frequency signal from said first RF transceiver (64) and for receiving radio frequency signals,
a Bluetooth transceiver (54) attached to said first printed circuit board (50) and electrically connected to said first microcontroller (52) for wireless communication with Bluetooth enabled personal electronic equipment (32) to adjust settings and monitor operation of said first control device (36),
at least one status LED (68) attached to said first printed circuit board (50) and protruding through one of said openings (48) disposed on said anterior portion (42) of said enclosure and electrically connected to said first microcontroller (52) for visual feedback to the user of the status of said first control device (36),
a wiring socket (56) attached to said first printed circuit board (50) and protruding through one of said openings (48) disposed on said wall (46) of said enclosure and electrically connected to said output drivers (28) and to said wiring connectors (26) of said heated clothing articles (22) and to a positive and a negative terminal of a vehicle power source,
said first memory of said first microcontroller (52) containing computer instructions for processing information received by said first RF transceiver (64) and controlling said status LED (68) and generating a pulse width modulated command to said output drivers (28) to alter the temperature of said heated clothing articles (22),
a second control device (74) including a housing having a top (76) and a bottom (78) and a front (80) and a back (82) and a pair of sides (84) defining an interior cavity and a plurality of apertures extending into said interior cavity,
a second printed circuit board (92) disposed in said interior cavity of said housing,
a second microcontroller (94) having a second memory attached to said second printed circuit board (92),
a second RF transceiver (108) attached to said second printed circuit board (92) and electrically connected to said second microcontroller (94) for wireless communication with said first RF transceiver (64),
a second antenna (110) attached to said second printed circuit board (92) and electrically connected to said second RF transceiver (108) for transmitting a second radio frequency signal from said second RF transceiver (108) and for receiving the first radio frequency signal from said first antenna (66),
said second memory including a Pulse Width Modulation (PWM) algorithm and a plurality of PWM lookup tables for processing adjustments to said output current of said output drivers (28) of said first control device (36) and communicating a PWM request to said first control device (36) by said second RF transceiver (108)
a micro USB port (98) attached to said second printed circuit board (92) and extending through one of said apertures disposed on said bottom (78) of said housing and electrically connected to said second microcontroller (94) for connection to a computer to reprogram and to configure settings and for connection to an external power supply,
a user input connected to said second control device (74) for user to signal temperature changes,
said heated clothing article (22) including at least one lighted logo (34) having a plurality of integrated lighting elements woven into said heated clothing article (22),
said heated clothing article (22) including an interface cable (30) for attachment to personal electronic equipment (32) to enable charging of and communication with the personal electronic equipment (32),
a reverse battery protection circuit (58) attached to said first printed circuit board (50) and electrically connected to said wiring socket (56) for protecting said first control device (36) from reversal of the positive terminal and negative terminal of the vehicle power source by disabling said first control device (36) operation,
a voltage regulator (60) attached to said first printed circuit board (50) and electrically connected to the vehicle power source for regulating voltage supplied to said first control device (36),
a voltage monitor (62) attached to said first printed circuit board (50) and electrically connected to said first microcontroller (52) and to said wiring socket (56) for monitoring the voltage of the vehicle power source,
at least one reverse polarity LED (70) attached to said first printed circuit board (50) and protruding through one of said openings (48) disposed on said anterior portion (42) of said enclosure for providing visual status feedback to the user in response to the user reversing the attachment of the positive terminal and the negative terminal of the vehicle power source to said wiring socket (56),
a plurality of heater output LEDs (72) attached to said first printed circuit board (50) and each protruding through one of said apertures disposed of said anterior portion (42) of said enclosure and electrically connected to said first microcontroller (52) for visual feedback to the user of the output of said output drivers (28),
said first memory of said first microcontroller (52) containing computer instructions for processing information received by said first RF transceiver (64) and by said Bluetooth transceiver (54) and controlling said reverse polarity LED (70) and said heater output LEDs (72),
a plurality of zones defined by said first memory of said first microcontroller (52) and each containing at least one of said heated clothing articles (22) for temperature adjustment of said heated clothing articles (22) by said first microcontroller (52),
said housing of said second control device (74) including a pair of protrusions (86) each disposed adjacent to one of said sides (84) and extending outwardly from said back (82) of said housing,
said protrusions (86) each defining a longitudinal slot (88) extending from said top (76) of said housing to said bottom (78) of said housing,
a flexible strap (90) having a plurality of hook and loop patches and extending through said longitudinal slots (88) between said protrusions (86) for securing said housing to a wrist of a user and to a vehicle brake reservoir and to a handlebar of a vehicle,
said user input being a pair of buttons (96) attached to said second printed circuit board (92) and each protruding through one of said apertures disposed on said front (80) of said housing and electrically connected to said second microcontroller (94) for user to signal temperature changes in response to said buttons (96) being depressed and used to control temperature in all of said zones,
a mobile battery (100) being rechargeable disposed in said interior portion of said housing and electrically connected to said micro USB port (98) and to said second microcontroller (94) for providing electrical power to said second control device (74) and being recharged by the external power supply through said micro USB port (98),
a plurality of comfort setting LEDs (102) attached to said second printed circuit board (92) and each protruding through one of said apertures disposed on said top (76) of said housing and electrically connected to said second microcontroller (94) for visual feedback to the user in response to the user depressing said buttons (96) and in response to said mobile battery (100) having a low state of charge and for visual status feedback to the user of activation of said second control device (74),
a light sensor (104) attached to said second printed circuit board (92) and aligned with one of said apertures disposed on said top (76) of said housing and electrically connected to said second microcontroller (94) for detecting ambient light and signaling said second microcontroller (94) to adjust the brightness of said comfort setting LEDs (102),
a temperature input attached to said second printed circuit board (92) and electrically connected to said second microcontroller (94) for generating an electrical output proportional to an ambient temperature,
said temperature input being a thermistor (106),
a velocity input attached to said second printed circuit board (92) and electrically connected to said second microcontroller (94) for transmitting a signal indicating a velocity of said housing to said second microcontroller (94),
said velocity input being an accelerometer (112),
said second RF transceiver (108) electrically connected to said second microcontroller (94) for wireless communication of readings from said buttons (96) and said accelerometer (112) and said light sensor (104) and said thermistor (106) to said first control device (36), and
said second memory of said second microcontroller (94) containing software instructions for monitoring said buttons (96) and said accelerometer (112) and said thermistor (106) and said light sensor (104) and processing and transmitting information to said first control device (36) and being reprogrammable by a personal computer (116) connected to said micro USB port (98) and by a smartphone and a tablet and a Bluetooth enabled personal electronic equipment (32).
